(19) United States
(12) Patent Application Publication
(10) Pub. No.: US 2026/0302365 A1
(43) Pub. Date: Oct. 1, 2026

(54) ALL-SOLID-STATE BATTERY AND METHOD FOR PRODUCING THE SAME

(71) Applicant: HONDA MOTOR CO., LTD., Tokyo (JP)

(72) Inventors: Hideaki SASAKI, Saitama (JP); Yoshihiko NAKAJIMA, Saitama (JP)

(21) Appl. No.: 19/629,677

(22) Filed: Mar. 26, 2026

(30) Foreign Application Priority Data
Mar. 31, 2025 (JP) 2025-057810

(51) Int. Cl. H01M 10/0585; H01M 50/186; H01M 50/536; H01M 50/54

(52) U.S. Cl. CPC H01M 10/0585; H01M 50/186; H01M 50/536; H01M 50/54

(57) ABSTRACT

An all-solid-state battery includes an electrode laminate in which a plurality of layers are laminated in a Z direction, and an outer casing film. The inside of the outer casing film is at a reduced pressure compared to the outside thereof. The outer casing film includes an intermediate portion between a housing portion and a sealing portion. The intermediate portion has an intermediate portion proximal end as an end on a housing portion side and an intermediate portion distal end as an end on a sealing portion side. The size in the X direction from the electrode laminate to the intermediate portion proximal end is smaller than the size in the X direction from the intermediate portion proximal end to the intermediate portion distal end.

This application is based on and claims the benefit of priority from Japanese Patent Application No. 2025-057810, filed on 31 Mar. 2025, the content of which is incorporated herein by reference.

### BACKGROUND OF THE INVENTION

### Filed of the invention

The present invention relates to an all-solid-state battery mounted on a vehicle or the like.

### Related Art

In recent years, research and development has been conducted on all-solid-state batteries that contribute to energy efficiency in order to ensure that more people have access to affordable, reliable, sustainable, and advanced energy.

Some all-solid-state batteries include an electrode laminate and an outer casing film. In the electrode laminate, a plurality of layers extending in predetermined X and Y directions are laminated in a Z direction. The outer casing film includes a housing portion that houses the electrode laminate therein, and a sealing portion that is provided around the housing portion when viewed in the Z direction.

The electrode laminate includes a positive electrode layer, a solid electrolyte layer, and a negative electrode layer as the above-described layers. Each of the positive electrode layer and the negative electrode layer includes a current collector. The current collectors are electrically connected to the corresponding tab leads. Each of the tab leads passes through the sealing portion of the outer casing film in the X direction and extends to the outside of the outer casing film.

Patent Document 1: Japanese Unexamined Patent Application, Publication No. 2023-136603

### SUMMARY OF THE INVENTION

In such an all-solid-state battery, the electrode laminate expands in the Z direction due to deposition of lithium or the like in the negative electrode layer during charging. On the other hand, during discharging, the electrode laminate contracts in the Z direction due to dissolution of lithium or the like in the negative electrode layer. An extra length is provided in the current collector so that the current collector is not disconnected even by such expansion or contraction. Therefore, the current collector is stored in the space between an end portion in the X direction of the electrode laminate and the outer casing film in a slightly bent state.

In the production stage of such an all-solid-state battery, the inside of the outer casing film is often brought to a reduced pressure. When an end surface in the X direction of the housing portion of the outer casing film is deformed to be recessed inward in the X direction by the pressure reduction, the portion of the tab lead welded to the sealing portion of the outer casing film is drawn inward in the X direction. As a result, the tab lead or the current collector may be damaged, or the tab lead or the current collector may bite into the electrode laminate.

Additionally, such deformation of the outer casing film inward in the X direction may cause the current collector to become sandwiched between the electrode laminate and the outer casing film. In this case, when the electrode laminate expands outward in the Z direction or contracts inward in the Z direction, the current collector may not be able to move well and may be damaged.

On the other hand, if the space between the end portion in the X direction of the electrode laminate and the outer casing film is made too large in the X direction in order to prevent the current collector from becoming sandwiched, the end portion in the X direction of the housing portion of the outer casing film is likely to deform inward in the Z direction due to the space.

The present invention has been made in view of the above circumstances, and an object of the present invention is to make an end portion, in an X direction, of a housing portion of an outer casing film less likely to deform both inward in the X direction and inward in a Z direction.

The present inventors have found that the above-described object can be achieved by providing a predetermined structure at an end portion of an outer casing film in an X direction, and have reached the present invention. The present invention relates to the following all-solid-state batteries according to a first aspect to a seventh aspect and the following method for producing an all-solid-state battery according to an eighth aspect.

A first aspect of the present invention is an all-solid-state battery including: an electrode laminate in which a plurality of layers extending in a predetermined X direction and a predetermined Y direction orthogonal to the X direction are laminated in a Z direction orthogonal to the X direction and the Y direction; and an outer casing film. The outer casing film includes a housing portion that houses the electrode laminate therein, and a sealing portion that is provided around the housing portion when viewed in the Z direction. An inside of the outer casing film is at a reduced pressure compared to an outside thereof. The electrode laminate includes, as the layers, at least a positive electrode layer, a solid electrolyte layer, and a negative electrode layer. Each of the positive electrode layer and the negative electrode layer includes a current collector. The current collector is electrically connected to a tab lead that passes through the sealing portion in the X direction and that extends to the outside of the outer casing film. The outer casing film includes an intermediate portion between the housing portion and a portion of the sealing portion welded to the tab lead. The intermediate portion has an intermediate portion proximal end as an end on a housing portion side and an intermediate portion distal end as an end on a sealing portion side. A space is formed between the electrode laminate and the intermediate portion proximal end. A size in the X direction from the electrode laminate to the intermediate portion proximal end is smaller than a size in the X direction from the intermediate portion proximal end to the intermediate portion distal end.

According to this configuration, by providing the intermediate portion between the housing portion and the sealing portion, it is possible to improve the rigidity in the X direction of the end portion of the housing portion in the X direction and the periphery thereof, and to make the housing portion less likely to deform inward in the X direction. Further, by making the size in the X direction from the electrode laminate to the intermediate portion proximal end smaller than the size in the X direction from the intermediate portion proximal end to the intermediate portion distal end, the space between the electrode laminate and the intermediate portion proximal end can be made smaller in the X direction. Accordingly, it is possible to make the end portion of the housing portion in the X direction less likely to deform also inward in the Z direction.

As described above, according to this configuration, it is possible to make the end portion in the X direction of the housing portion of the outer casing film less likely to deform both inward in the X direction and inward in the Z direction.

In a second aspect of the present invention according to the first aspect, a protrusion protruding outward in the Z direction with respect to a portion of the housing portion that abuts against an end surface of the electrode laminate in the Z direction is formed in a portion of the housing portion between the end surface of the electrode laminate in the Z direction and the intermediate portion proximal end.

According to this configuration, by bending the outer casing film outward in the Z direction, deformation inward in the X direction can be efficiently suppressed.

In a third aspect of the present invention according to the first or second aspect, the intermediate portion proximal end is provided in a central region of three regions defined by division, in the Z direction, of a region from an end of the outer casing film in the Z direction to the tab lead into three equal regions.

According to this configuration, since the intermediate portion protrudes outward in the X direction from the central region in the Z direction, the rigidity of the end portion of the outer casing film in the X direction can be efficiently improved.

In a fourth aspect of the present invention according to any one of the first to third aspects, when viewed in a natural state before the inside of the outer casing film is brought to the reduced pressure, the intermediate portion has a parallel portion extending in the X direction and the Y direction substantially parallel to the sealing portion between the intermediate portion proximal end and the intermediate portion distal end.

According to this configuration, a stepped shape can be efficiently provided. The stepped shape can efficiently improve the rigidity of the end portion of the outer casing film in the X direction.

In a fifth aspect of the present invention according to any one of the first to third aspects, when viewed in the Y direction, the intermediate portion has an inclined portion extending in a direction oblique to the X direction between the intermediate portion proximal end and the intermediate portion distal end.

According to this configuration, a force that would otherwise act inward in the X direction on the end portion of the outer casing film in the X direction can be directed by the inclined portion in a direction oblique to the inward X direction. This efficiently suppresses deformation of the outer casing film inward in the X direction.

In a sixth aspect of the present invention according to any one of the first to fifth aspects, a length of the intermediate portion distal end in the Y direction is smaller than a length of the intermediate portion proximal end in the Y direction. When viewed in the Z direction, at an end of the intermediate portion in the Y direction, an angle of a virtual straight line connecting the intermediate portion proximal end and the intermediate portion distal end with respect to the X direction is greater than 45°.

This configuration makes it easier to form the intermediate portion and the peripheral portion thereof.

In a seventh aspect of the present invention according to any one of the first to sixth aspects, at an end of the intermediate portion in the Y direction, a predetermined proximal end side section is provided on a portion located toward the intermediate portion proximal end relative to a predetermined portion, and a predetermined distal end side section is provided on a portion located toward the intermediate portion distal end relative to the predetermined portion. When viewed in the Z direction, an angle of an extending direction of the distal end side section with respect to the X direction is greater than an angle of an extending direction of the proximal end side section with respect to the X direction.

According to this configuration, by reducing the angle of the extending direction of the proximal end side section with respect to the X direction, the extending direction of the proximal end side section can be made closer to the X direction, and the rigidity of the end portion of the outer casing film in the X direction can be improved. Additionally, by increasing the angle of the extending direction of the distal end side section with respect to the X direction, it becomes easier to form the intermediate portion and the periphery thereof.

An eighth aspect of the present invention is a method for producing an all-solid-state battery. The all-solid-state battery includes: an electrode laminate in which a plurality of layers extending in a predetermined X direction and a predetermined Y direction orthogonal to the X direction are laminated in a Z direction orthogonal to the X direction and the Y direction; and an outer casing film. The outer casing film includes a housing portion that houses the electrode laminate therein, and a sealing portion that is provided around the housing portion when viewed in the Z direction. An inside of the outer casing film is at a reduced pressure compared to an outside thereof. The electrode laminate includes, as the layers, at least a positive electrode layer, a solid electrolyte layer, and a negative electrode layer. Each of the positive electrode layer and the negative electrode layer includes a current collector. The current collector is electrically connected to a tab lead that passes through the sealing portion in the X direction and that extends to the outside of the outer casing film. In a pre-pressure reduction stage before the inside of the outer casing film is brought to the reduced pressure, the outer casing film includes an intermediate portion between the housing portion and a portion of the sealing portion welded to the tab lead. The intermediate portion has an intermediate portion proximal end as an end on a housing portion side and an intermediate portion distal end as an end on a sealing portion side. A space is formed between the electrode laminate and the intermediate portion proximal end. A size in the X direction from the electrode laminate to the intermediate portion proximal end is smaller than a size in the X direction from the intermediate portion proximal end to the intermediate portion distal end. The method includes reducing pressure of the inside of the outer casing film from a state of the pre-pressure reduction stage.

This production method also provides the same effects as in the case of the first aspect above.

As described above, according to the all-solid-state battery of the first aspect and the production method of the eighth aspect, it is possible to make the end portion in the X direction of the housing portion of the outer casing film less likely to deform both inward in the X direction and inward in the Z direction. Further, according to the configurations of the second to seventh aspects that cite the first aspect, respective additional effects can be obtained.

### BRIEF DESCRIPTION OF THE DRAWINGS

FIG. 1 is a perspective view of an all-solid-state battery according to a first embodiment before pressure reduction;

FIG. 2 is a plan view of the all-solid-state battery before pressure reduction;

FIG. 3 is an enlarged view of the portion of fg3 in FIG. 2;

FIG. 4 is a cross-sectional view taken along line fg4-fg4 in FIG. 2;

FIG. 5 is a cross-sectional view taken along line fg5-fg5 in FIG. 3;

FIG. 6 is a plan view showing the all-solid-state battery after pressure reduction;

FIG. 7 is a cross-sectional view taken along line fg7-fg7 in FIG. 6;

FIG. 8 is a plan view showing an all-solid-state battery of a comparative embodiment after pressure reduction;

FIG. 9 is a cross-sectional view taken along line fg9-fg9 in FIG. 8;

FIG. 10 is a perspective view of an all-solid-state battery according to a second embodiment before pressure reduction;

FIG. 11 is a cross-sectional view of the all-solid-state battery before pressure reduction when viewed in a Y direction;

FIG. 12 is a cross-sectional view of the all-solid-state battery after pressure reduction when viewed in the Y direction;

FIG. 13 is a perspective view of an all-solid-state battery according to a third embodiment before pressure reduction; and

FIG. 14 is a perspective view of an all-solid-state battery according to a fourth embodiment before pressure reduction.

### DETAILED DESCRIPTION OF THE INVENTION

Hereinafter, embodiments of the present invention will be described with reference to the drawings. However, the present invention is not limited to the following embodiments, and can be modified and implemented as appropriate within a range not departing from the gist of the present invention.

### First Embodiment

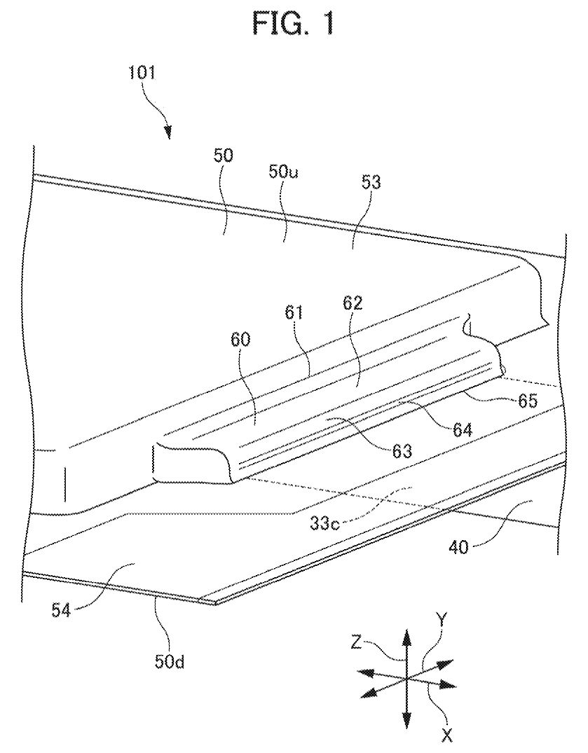

Hereinafter, as shown in FIG. 1, predetermined three directions orthogonal to each other are referred to as an "X direction", a "Y direction", and a "Z direction". In the present embodiment, the Z direction is the vertical direction, and the X direction and the Y direction are the horizontal directions. Alternatively, instead of this, for example, the Z direction may be a direction oblique to the vertical direction, and the X direction and the Y direction may be directions orthogonal to the direction oblique to the vertical direction. Alternatively, for example, one of the X direction and the Y direction may be the vertical direction, and the other of the X direction and the Y direction and the Z direction may be the horizontal directions.

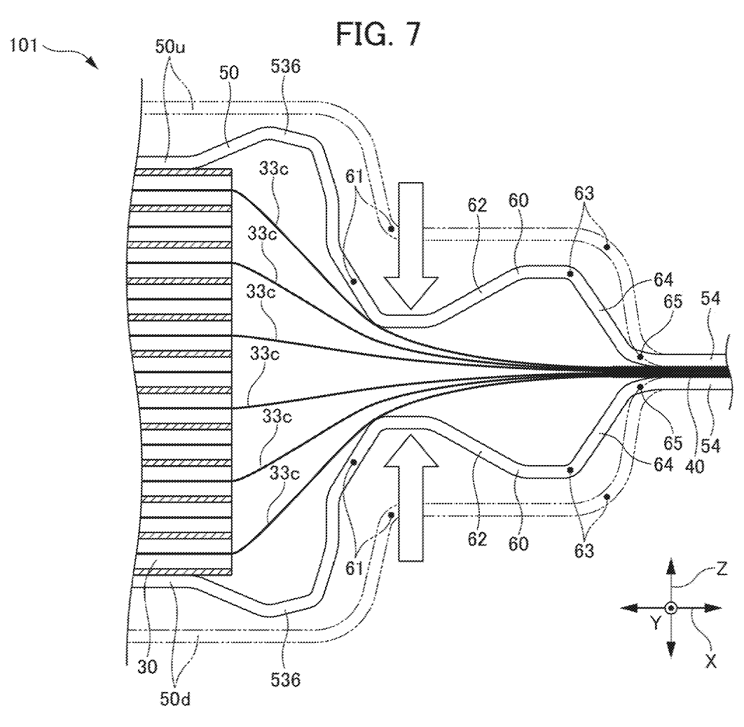

As shown in FIG. 7, an all-solid-state battery 101 includes an electrode laminate 30 and an outer casing film 50. The inside of the outer casing film 50 has a reduced pressure compared to the outside thereof. Hereinafter, the state before such pressure reduction is referred to as "before pressure reduction", and the state after such pressure reduction is referred to as "after pressure reduction". Additionally, the stage before pressure reduction is referred to as a "pre-pressure reduction stage", and the stage after pressure reduction is referred to as a "post-pressure reduction stage". The state before pressure reduction is referred to as a "natural state", and the state after pressure reduction is referred to as a "product state".

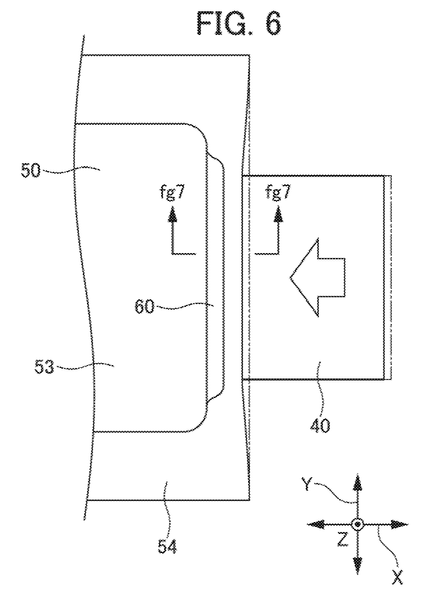

FIGS. 1 to 5 show the all-solid-state battery 101 in a pre-pressure reduction stage. On the other hand, FIGS. 6 and 7 show the all-solid-state battery 101 in a post-pressure reduction stage.

First, the all-solid-state battery 101 in the pre-pressure reduction stage shown in FIGS. 1 to 5, that is, the all-solid-state battery 101 in which the outer casing film 50 is in a natural state will be described.

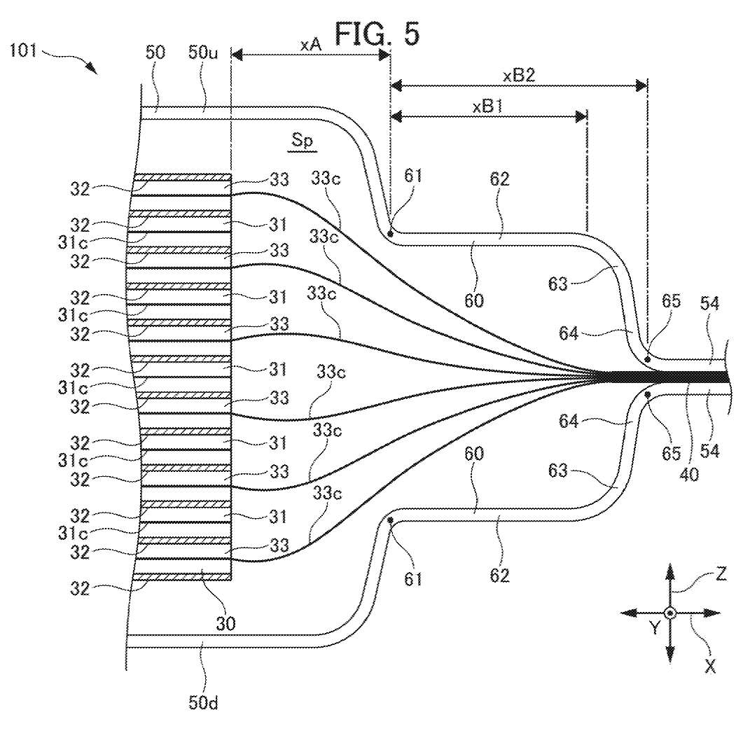

As shown in FIG. 5, the outer casing film 50 includes a first film 50u and a second film 50d arranged in the Z direction. Alternatively, the outer casing film 50 may be formed of one folded film.

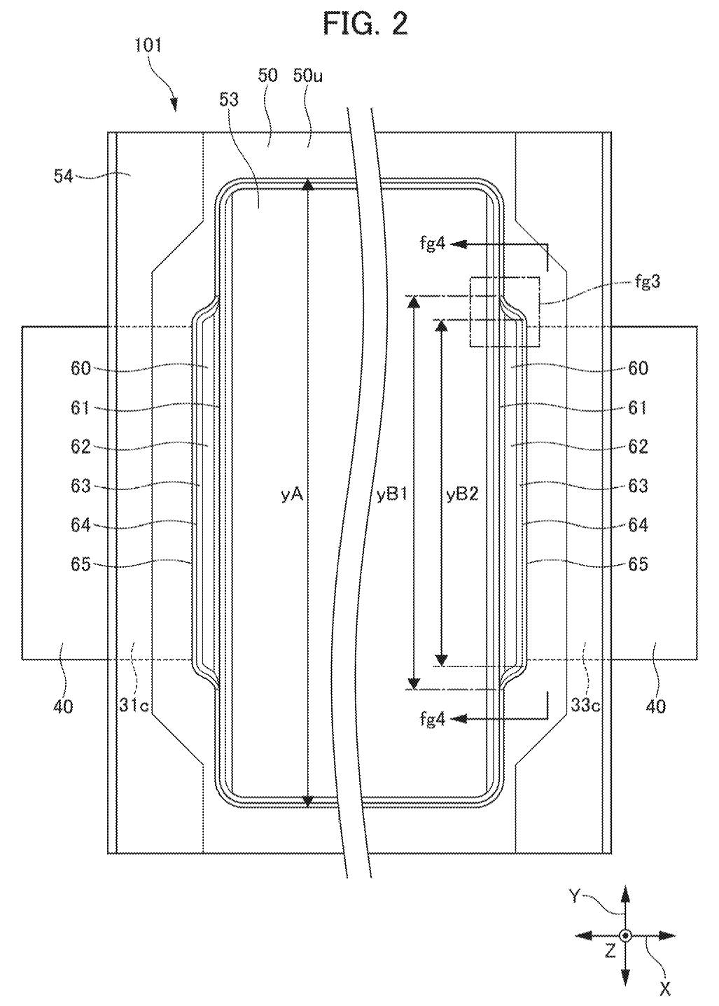

Each of the first film 50u and the second film 50d includes a housing portion 53 and a sealing portion 54. The housing portion 53 houses the electrode laminate 30 therein. As shown in FIG. 2, the sealing portion 54 is provided around the housing portion 53 when viewed in the Z direction. In the pre-pressure reduction stage, a portion of the sealing portion 54 is opened. The all-solid-state battery 101 includes a tab lead 40 on the positive electrode side on one side in the X direction and a tab lead 40 on the negative electrode side on the other side in the X direction.

As shown in FIG. 5, the electrode laminate 30 is formed by laminating, in the Z direction, a plurality of layers extending in the X direction and the Y direction. The electrode laminate 30 includes a positive electrode layer 31, a solid electrolyte layer 32, and a negative electrode layer 33 as the layers.

The positive electrode layer 31 includes a positive electrode current collector 31c, and the negative electrode layer 33 includes a negative electrode current collector 33c. The negative electrode current collector 33c protrudes toward the tab lead 40 on the negative electrode side and is electrically connected to the tab lead 40. The positive electrode current collector 31c protrudes toward the tab lead 40 on the positive electrode side shown in FIG. 2 and is electrically connected to the tab lead 40. Hereinafter, the positive electrode current collector 31c and the negative electrode current collector 33c will be collectively referred to as "current collectors 31c and 33c".

As shown in FIG. 2, the tab lead 40 on each of the positive electrode side and the negative electrode side passes through the sealing portion 54 in the X direction and extends to the outside of the outer casing film 50. As shown in FIG. 5, the tab lead 40 is provided at the central portion of the all-solid-state battery 101 in the Z direction. Alternatively, the tab lead 40 may be provided at one end portion of the all-solid-state battery 101 in the Z direction. Further, one of the first film 50u and the second film 50d may be provided in a planar shape extending in the X direction and the Y direction, unlike the shape shown in FIG. 5.

As shown in FIG. 5, each of the first film 50u and the second film 50d has an intermediate portion 60 between the housing portion 53 and a portion of the sealing portion 54 welded to the tab lead 40. The intermediate portion 60 has an intermediate portion proximal end 61 as an end on the housing portion 53 side and an intermediate portion distal end 65 as an end on the sealing portion 54 side.

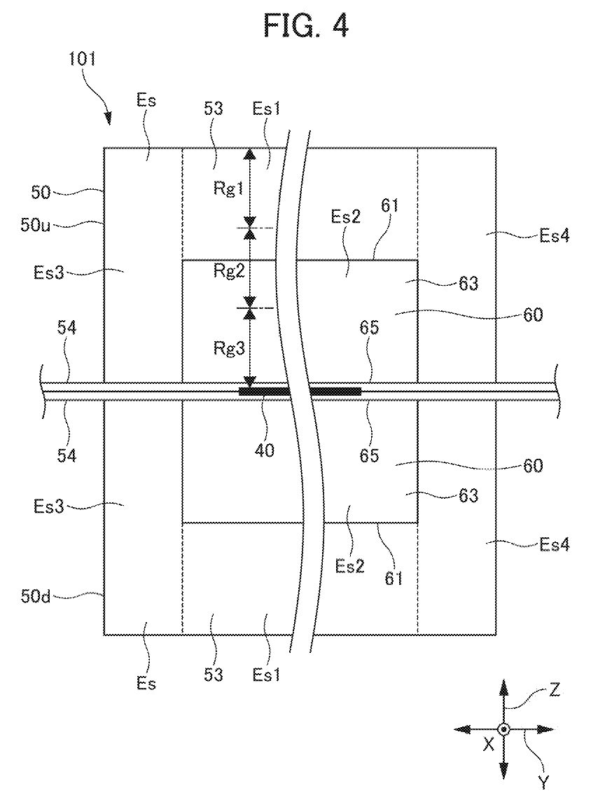

As shown in FIG. 4, when viewed in the X direction, the intermediate portion proximal end 61 is located between the end of the outer casing film 50 in the Z direction and the tab lead 40. More specifically, the intermediate portion proximal end 61 is provided in the central region Rg2 of three regions Rg1, Rg2, and Rg3 defined by division, in the Z direction, of the region from the end of the outer casing film 50 in the Z direction to the tab lead 40 into three equal regions.

As shown in FIG. 5, a space Sp is formed between the electrode laminate 30 and the intermediate portion proximal end 61. The intermediate portion 60 extends from the intermediate portion proximal end 61 to a bent portion 63 located outside the intermediate portion proximal end 61 in the X direction, and then extends to the intermediate portion distal end 65.

As shown in FIG. 1, the intermediate portion 60 has a parallel portion 62 extending in the X direction and the Y direction parallel or substantially parallel to the sealing portion 54 between the intermediate portion proximal end 61 and the bent portion 63. The intermediate portion 60 further has a vertical portion 64 extending in the Z direction perpendicular or substantially perpendicular to the sealing portion 54 between the bent portion 63 and the intermediate portion distal end 65.

As shown in FIG. 5, the size xA in the X direction from the electrode laminate 30 to the intermediate portion proximal end 61 is smaller than the size xB2 in the X direction from the intermediate portion proximal end 61 to the intermediate portion distal end 65, and is also smaller than the size xB1 in the X direction from the intermediate portion proximal end 61 to the bent portion 63.

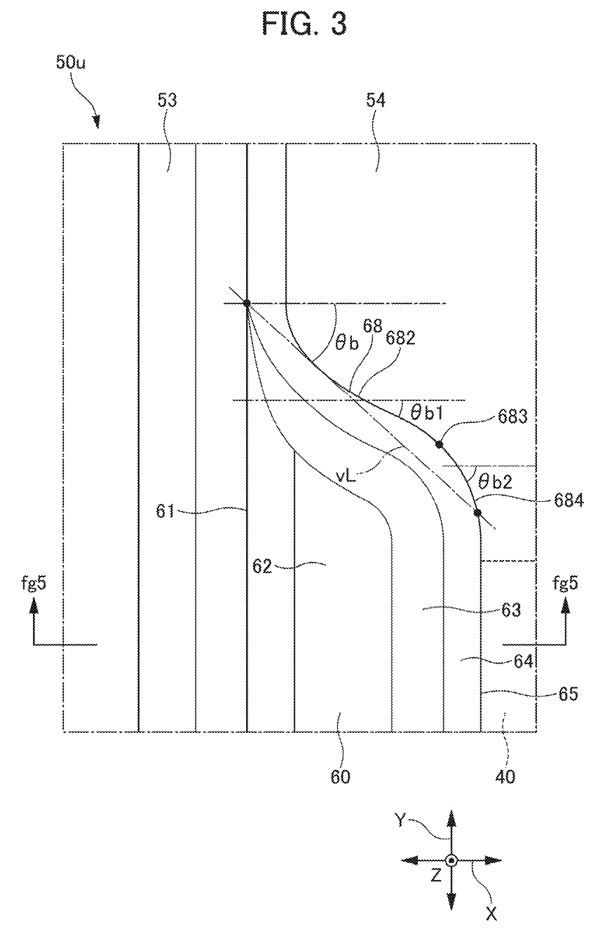

As shown in FIG. 2, the length yB1 of the intermediate portion proximal end 61 in the Y direction is smaller than the length yA of the housing portion 53 in the Y direction. Specifically, the length yB1 of the intermediate portion proximal end 61 in the Y direction is 30 to 80% of the length yA of the housing portion 53 in the Y direction. Thus, the intermediate portion 60 protrudes outward in the X direction from between both ends of the housing portion 53 in the Y direction. The length yB2 of the intermediate portion distal end 65 in the Y direction is smaller than the length yB1 of the intermediate portion proximal end 61 in the Y direction. Thus, as shown in FIG. 3, when viewed in the Z direction, a vertical straight line vL connecting the intermediate portion proximal end 61 and the intermediate portion distal end 65 at an end 68 of the intermediate portion 60 in the Y direction is oblique to the X direction. That is, the virtual straight line vL extends inward in the Y direction as it extends outward in the X direction.

More specifically, as shown in FIG. 3, when viewed in the Z direction, the angle θb of the virtual straight line vL with respect to the X direction is greater than 45°. At the end 68 of the intermediate portion 60 in the Y direction, a predetermined proximal end side section 682 is provided on a portion located toward the intermediate portion proximal end 61 relative to a predetermined portion 683. Further, at the end 68, a predetermined distal end side section 684 is provided on a portion located toward the intermediate portion distal end 65 relative to the predetermined portion 683. As described above, when viewed in the Z direction, the angle θb2 of the extending direction of the distal end side section 684 with respect to the X direction is greater than the angle θb1 of the extending direction of the proximal end side section 682 with respect to the X direction.

The foregoing describes the all-solid-state battery 101 in the pre-pressure reduction stage, that is, the all-solid-state battery 101 in which the outer casing film 50 is in the natural state.

Next, a method for producing the all-solid-state battery 101 of the present embodiment, that is, a method for producing the all-solid-state battery 101 in a product state will be described. In this production method, the pressure of the inside of the outer casing film 50 is reduced from the state of the pre-pressure reduction stage described above to completely seal the sealing portion 54. Thereby, the all-solid-state battery 101 in the post-pressure reduction stage shown in FIGS. 6 and 7, that is, the all-solid-state battery 101 in the product state is completed.

Hereinafter, the all-solid-state battery 101 in the product state will be described.

As shown in FIG. 7, also in the product state, the intermediate portion proximal end 61 is located inward in the Z direction relative to the end of the outer casing film 50 in the Z direction and outward in the Z direction relative to the tab lead 40. Therefore, also in the product state, as in the case of the natural state shown in FIG. 4, when viewed in the X direction, the intermediate portion proximal end 61 is located between the end of the outer casing film 50 in the Z direction and the tab lead 40. More specifically, also in the product state, as in the case of the natural state shown in FIG. 4, the intermediate portion proximal end 61 is provided in the central region Rg2 of the three regions Rg1, Rg2, and Rg3 defined by division, in the Z direction, of the region from the end of the outer casing film 50 in the Z direction to the tab lead 40 into three equal regions.

As shown in FIG. 7, also in the product state, the intermediate portion 60 extends from the intermediate portion proximal end 61 to the bent portion 63 located outside the intermediate portion proximal end 61 in the X direction, and then extends to the intermediate portion distal end 65. Also in the product state, as in the case of the natural state shown in FIG. 5, the size xA in the X direction from the electrode laminate 30 to the intermediate portion proximal end 61 is smaller than the size xB2 in the X direction from the intermediate portion proximal end 61 to the intermediate portion distal end 65, and is also smaller than the size xB1 in the X direction from the intermediate portion proximal end 61 to the bent portion 63.

Also in the product state, as in the case of the natural state shown in FIG. 2, the length yB1 of the intermediate portion proximal end 61 in the Y direction is smaller than the length yA of the housing portion 53 in the Y direction, and the length yB1 of the intermediate portion proximal end 61 in the Y direction is 30 to 80% of the length yA of the housing portion 53 in the Y direction. Thus, also in the product state, the intermediate portion 60 protrudes in the X direction from between both ends of the housing portion 53 in the Y direction. Also in the product state, the length yB2 of the intermediate portion distal end 65 in the Y direction is smaller than the length yB1 of the intermediate portion proximal end 61 in the Y direction. Thus, also in the product state, as in the case of the natural state shown in FIG. 3, when viewed in the Z direction, the virtual straight line vL is oblique to the X direction. More specifically, also in the product state, as in the case of the natural state shown in FIG. 3, when viewed in the Z direction, the angle θb of the virtual straight line vL with respect to the X direction is greater than 45°. Also in the product state, as in the case of the natural state shown in FIG. 3, when viewed in the Z direction, the angle θb2 of the extending direction of the distal end side section 684 with respect to the X direction is greater than the angle θb1 of the extending direction of the proximal end side section 682 with respect to the X direction.

As shown in FIG. 7, in the product state, a protrusion 536 protruding outward in the Z direction relative to a portion of the housing portion 53 that abuts against the end surface of the electrode laminate 30 in the Z direction is formed in a portion of the housing portion 53 between the electrode laminate 30 and the intermediate portion proximal end 61.

The foregoing describes the all-solid-state battery 101 in the product state, that is, the all-solid-state battery 101 in the post-pressure reduction stage.

Hereinafter, the present embodiment will be described in more detail.

The positive electrode layer 31 shown in FIG. 5 includes a positive electrode active material layer. The negative electrode layer 33 includes a negative electrode active material layer. The solid electrolyte layer 32 is provided between the positive electrode layer 31 and the negative electrode layer 33. When the all-solid-state battery 101 is charged, the electrode laminate 30 expands outward in the Z direction due to deposition of lithium or the like in the negative electrode layer 33. On the other hand, during discharge, the electrode laminate 30 contracts inward in the Z direction due to dissolution of lithium or the like in the negative electrode layer 33. The current collectors 31c and 33c are provided with extra lengths so that the current collectors 31c and 33c are not disconnected even by such expansion or contraction. Therefore, the current collectors 31c and 33c are stored in the space Sp between the end portion of the electrode laminate 30 in the X direction and the outer casing film 50 in a slightly bent state.

Both the first film 50u and the second film 50d of the outer casing film 50 are laminate films. In the present embodiment, the first film 50u and the second film 50d are provided substantially symmetrically in the Z direction. Alternatively, as described above, the tab lead 40 may be provided at one end of the all-solid-state battery 101 in the Z direction, and one of the first film 50u and the second film 50d may have a planar shape extending in the X direction and the Y direction.

The size xA in the X direction from the electrode laminate 30 to the intermediate portion proximal end 61 shown in FIG. 5 is about 2 mm. On the other hand, the size xB2 in the X direction from the intermediate portion proximal end 61 to the intermediate portion distal end 65 is about 4 mm. The size in the Z direction from the end of the outer casing film 50 in the Z direction to the tab lead 40 is about 4 mm.

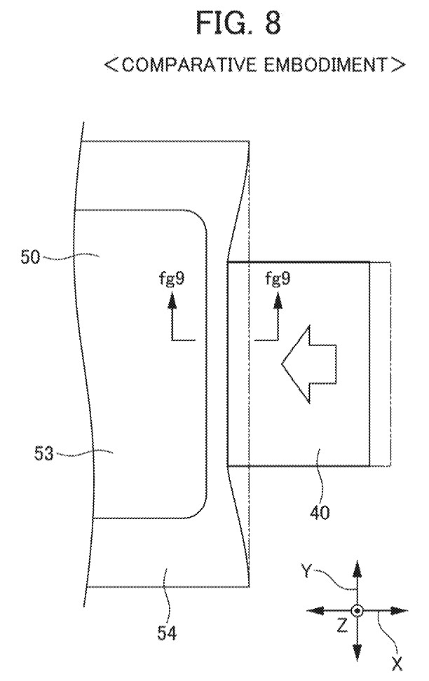

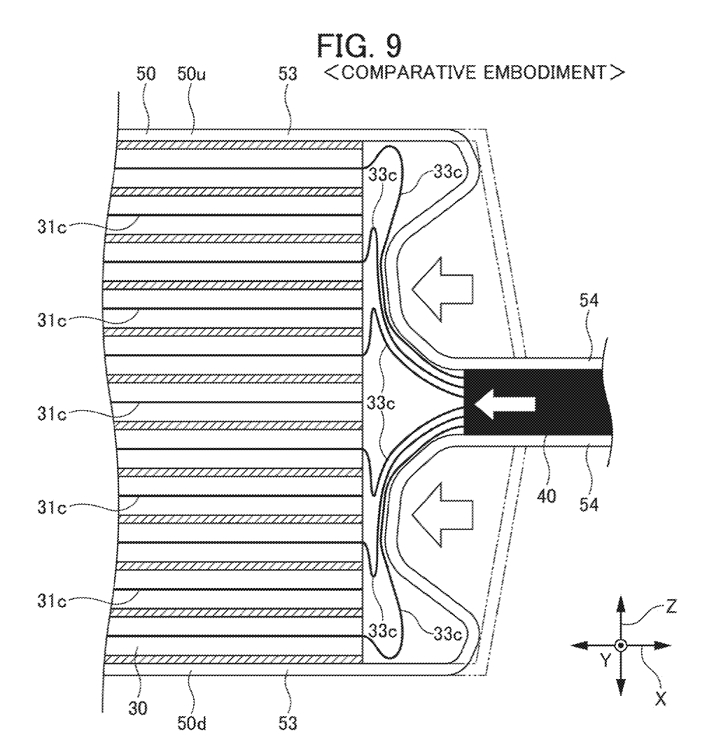

Hereinafter, as shown in FIGS. 8 and 9, an embodiment in which the intermediate portion 60 is omitted from the present embodiment is referred to as a comparative embodiment.

As shown in FIG. 9, in this comparative embodiment, the end surface in the X direction of the housing portion 53 of the outer casing film 50 is deformed so as to be recessed inward in the X direction due to the reduction in pressure of the inside of the outer casing film 50, and the portion of the tab lead 40 welded to the sealing portion 54 is drawn inward in the X direction. As a result, the tab lead 40 or the current collector 33c may be damaged, or the tab lead 40 or the current collector 33c may bite into the electrode laminate 30.

Additionally, the current collector 33c may be sandwiched between the electrode laminate 30 and the outer casing film 50 due to the deformation of the outer casing film 50 inward in the X direction accompanying the pressure reduction. In this case, when the electrode laminate 30 expands outward in the Z direction or contracts inward in the Z direction, the current collector 33c may not move well and may be damaged.

The configuration and effects of the present embodiment will be summarized below while comparing with this comparative embodiment.

As shown in FIG. 4, the intermediate portion proximal end 61 is located between the end of the outer casing film 50 in the Z direction and the tab lead 40 when viewed in the X direction. As shown in FIG. 5, the intermediate portion 60 extends from the intermediate portion proximal end 61 to the bent portion 63 located outside the intermediate portion proximal end 61 in the X direction, and then extends to the intermediate portion distal end 65. Therefore, as shown in FIG. 4, the end surface Es of the outer casing film 50 in the X direction can be divided in the Z direction. Specifically, a first dividing surface Es1 is formed outside the intermediate portion proximal end 61 in the Z direction, and a second dividing surface Es2 is formed inside the bent portion 63 in the Z direction.

Further, as shown in FIG. 2, the intermediate portion 60 protrudes outward in the X direction from between both ends of the housing portion 53 in the Y direction. Therefore, as shown in FIG. 4, the end surface of the outer casing film 50 in the X direction can also be divided in the Y direction. Specifically, a third dividing surface Es3 is formed on one side of the intermediate portion 60 in the Y direction, and a fourth dividing surface Es4 is formed on the other side of the intermediate portion 60 in the Y direction. As described above, the first dividing surface Es1 and the second dividing surface Es2 are formed to be arranged in the Z direction between the third dividing surface Es3 and the fourth dividing surface Es4.

From the above, it is possible to divide the end surface Es of the outer casing film 50 in the X direction, that is, the surface of the outer casing film 50 that receives the outside air pressure inward in the X direction, in the Y direction and the Z direction. Accordingly, the rigidity of the end portion of the outer casing film 50 in the X direction can be improved, and the deformation of the outer casing film 50 inward in the X direction accompanying the reduction in pressure of the inside of the outer casing film 50 can be suppressed.

As a result, as shown in FIG. 7, compared to the comparative embodiment shown in FIG. 9, it is possible to suppress the retraction of the tab lead 40 accompanying the deformation. As a result, the tab lead 40 and the current collectors 31c and 33c can be suppressed from being damaged, and biting into the electrode laminate 30.

Additionally, since the deformation of the outer casing film 50 inward in the X direction can be suppressed in this manner, the current collectors 31c and 33c can be suppressed from being sandwiched between the electrode laminate 30 and the outer casing film 50. Thus, when the electrode laminate 30 expands outward in the Z direction or contracts inward in the Z direction, the current collectors 31c and 33c move more easily, and the current collectors 31c and 33c are less likely to be damaged.

As shown in FIG. 4, the intermediate portion proximal end 61 is located in the central region Rg2 of the three regions Rg1, Rg2, and Rg3 defined by division, in the Z direction, of the region from the end of the electrode laminate 30 in the Z direction to the tab lead 40 into three equal regions. Since the intermediate portion 60 protrudes outward in the X direction from the inside of the central region Rg2 in the Z direction, the end surface of the outer casing film 50 in the X direction can be divided in the Z direction in a well-balanced manner, and the rigidity of the end portion of the outer casing film 50 in the X direction can be efficiently improved.

The length yB1 of the intermediate portion proximal end 61 in the Y direction shown in FIG. 2 is 30 to 80% of the length yA of the housing portion 53 in the Y direction. As a result, the end surface of the outer casing film 50 in the X direction can be divided in the Y direction in a well-balanced manner, and the rigidity of the end portion of the outer casing film 50 in the X direction can be efficiently improved.

As shown in FIG. 1, when viewed in the natural state, the intermediate portion 60 has the parallel portion 62 extending in the X direction and the Y direction substantially parallel to the sealing portion 54 between the intermediate portion proximal end 61 and the bent portion 63. This allows a stepped shape to efficiently formed. The rigidity of the end portion of the outer casing film 50 in the X direction can be efficiently improved by the stepped shape.

As shown in FIG. 2, when viewed in the Z direction, the length of the intermediate portion distal end 65 in the Y direction is smaller than the length of the intermediate portion proximal end 61 in the Y direction. Thus, when viewed in the Z direction in the natural state as shown in FIG. 3, at the end 68 of the intermediate portion 60 in the Y direction, the angle of the virtual straight line vL connecting the intermediate portion proximal end 61 and the intermediate portion distal end 65 with the X direction is greater than 45°. This makes it easier to form the intermediate portion 60 and the periphery thereof.

As shown in FIG. 3, at the end 68 of the intermediate portion 60 in the Y direction, the predetermined proximal end side section 682 is provided on the portion located toward the intermediate portion proximal end 61 relative to the predetermined portion 683. Further, at the end 68, the predetermined distal end side section 684 is provided on the portion located toward the intermediate portion distal end 65 relative to the predetermined portion 683. As shown in FIG. 3, when viewed in the Z direction in the natural state, the angle θb2 of the extending direction of the distal end side section 684 with respect to the X direction is greater than the angle θb1 of the extending direction of the proximal end side section 682 with respect to the X direction.

In this way, by reducing the angle θb1 of the extending direction of the proximal end side section 682 with respect to the X direction, the rigidity of the end portion of the outer casing film 50 in the X direction can be efficiently improved. On the other hand, by increasing the angle θb2 of the extending direction of the distal end side section 684 with respect to the X direction, it becomes easier to form the intermediate portion 60 and the periphery thereof.

As shown in FIG. 5, when viewed in the natural state, the size xA in the X direction from the electrode laminate 30 to the intermediate portion proximal end 61 is smaller than the size xB2 in the X direction from the intermediate portion proximal end 61 to the intermediate portion distal end 65, and is also smaller than the size xB1 in the X direction from the intermediate portion proximal end 61 to the bent portion 63. Accordingly, the space Sp between the electrode laminate 30 and the intermediate portion proximal end 61 can be reduced in the X direction. This makes it possible to make the end portion in the X direction of the housing portion 53 of the outer casing film 50 less likely to deform not only inward in the X direction but also inward in the Z direction.

As shown in FIG. 7, in the product state, the protrusion 536 protruding outward in the Z direction relative to the portion of the housing portion 53 that abuts against the end surface of the electrode laminate 30 in the Z direction is formed in the portion of the housing portion 53 between the electrode laminate 30 and the intermediate portion proximal end 61. By bending the outer casing film 50 outward in the Z direction in this manner, deformation inward in the X direction can be efficiently suppressed.

### Second Embodiment

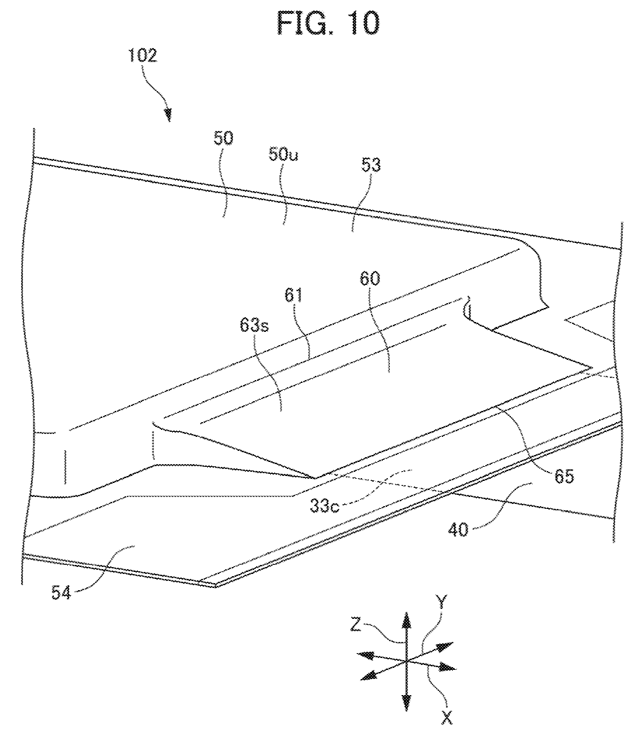

Next, with reference to FIGS. 10 to 12, an all-solid-state battery 102 according to a second embodiment will be described. In the present embodiment, differences from the first embodiment will be mainly described based on the first embodiment, and descriptions of the same or similar points as those of the first embodiment will be omitted as appropriate.

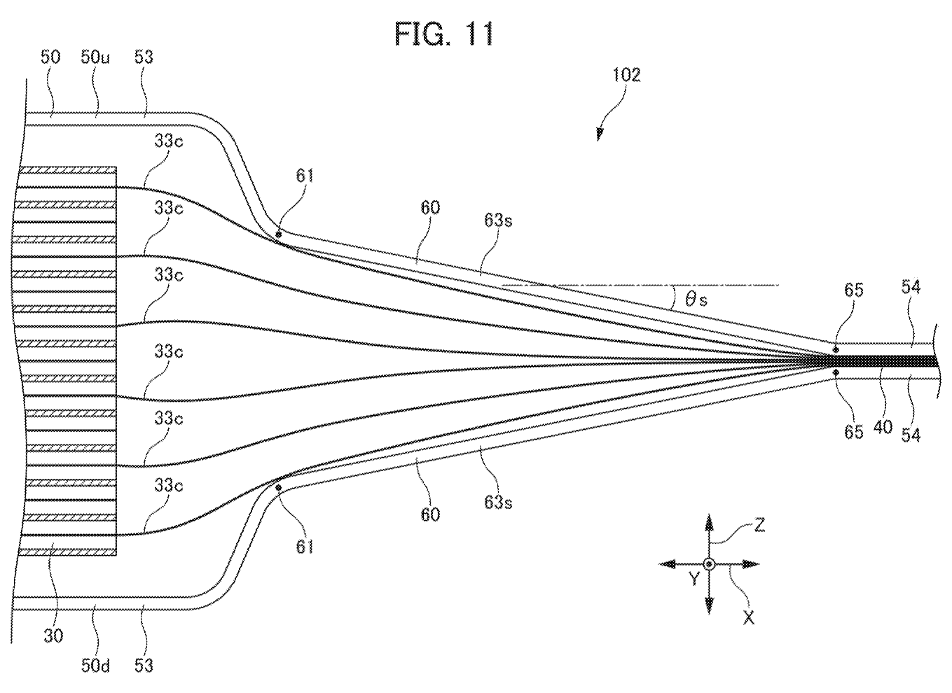

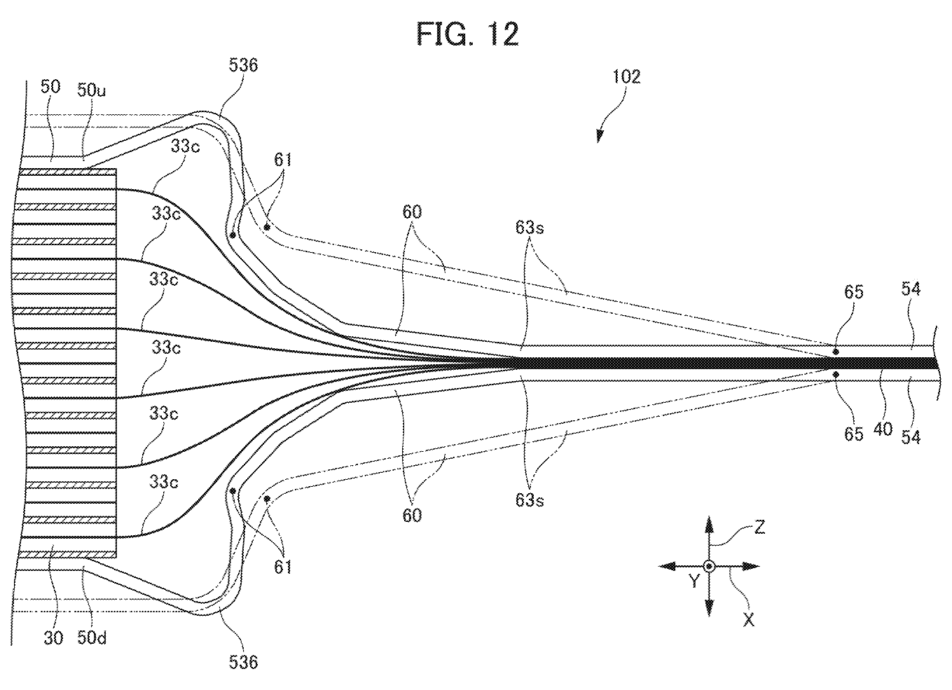

As shown in FIG. 10, the intermediate portion 60 has an inclined portion 63s between the intermediate portion proximal end 61 and the intermediate portion distal end 65 instead of the parallel portion 62, the bent portion 63, and the vertical portion 64 described in the first embodiment. As shown in FIG. 11, when viewed in the Y direction in a natural state, the inclined portion 63s extends in a direction oblique to the X direction. That is, the inclined portion 63s extends inward in the Z direction as it extends outward in the X direction. Specifically, when viewed in the Y direction in the natural state, the angle θs of the extending direction of the inclined portion 63s with respect to the X direction is 7° to 35°. As shown in FIG. 12, the inclined portion 63s is also present in a product state. Also in the product state, when viewed in the Y direction, the angle of the extending direction of the inclined portion 63s with respect to the X direction is 7° to 35°.

According to the present embodiment, by providing such an inclined portion 63s, a force that would otherwise act inward in the X direction on the outer casing film 50 when reducing the pressure of the inside of the outer casing film 50 can be directed in a direction oblique to the inward X direction. Thereby, as shown in FIG. 12, the deformation of the housing portion 53 of the outer casing film 50 inward in the X direction can be efficiently suppressed.

### Third Embodiment

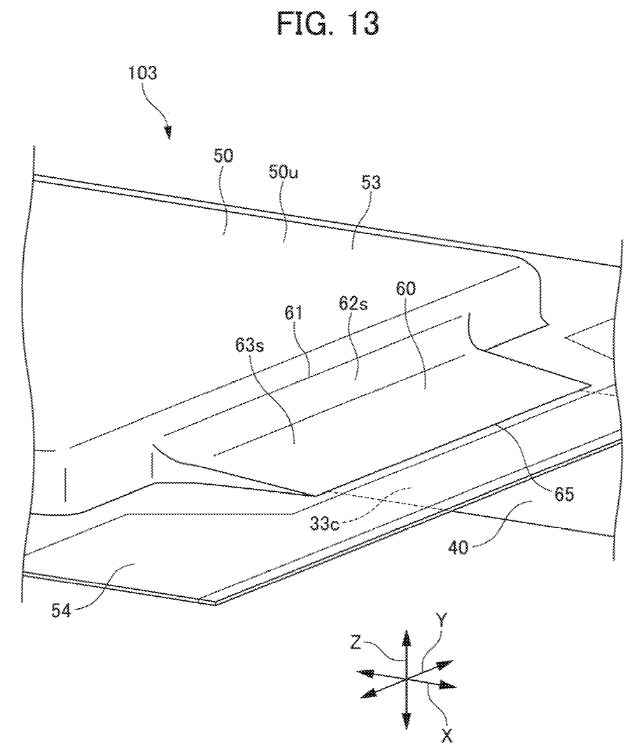

Next, with reference to FIG. 13, an all-solid-state battery 103 according to a third embodiment will be described. In the present embodiment, differences from the second embodiment will be mainly described based on the second embodiment, and descriptions of the same or similar points as those of the second embodiment will be omitted as appropriate.

A proximal end side inclined portion 62s is provided on the intermediate portion proximal end 61 side of the inclined portion 63s in the intermediate portion 60. When viewed in the Y direction in a natural state, the angle of the extending direction of the proximal end side inclined portion 62s with respect to the X direction is greater than the angle of the extending direction of the inclined portion 63s with respect to the X direction. The present embodiment is effective when it is desired to make the inclined portion 63s more gradual.

### Fourth Embodiment

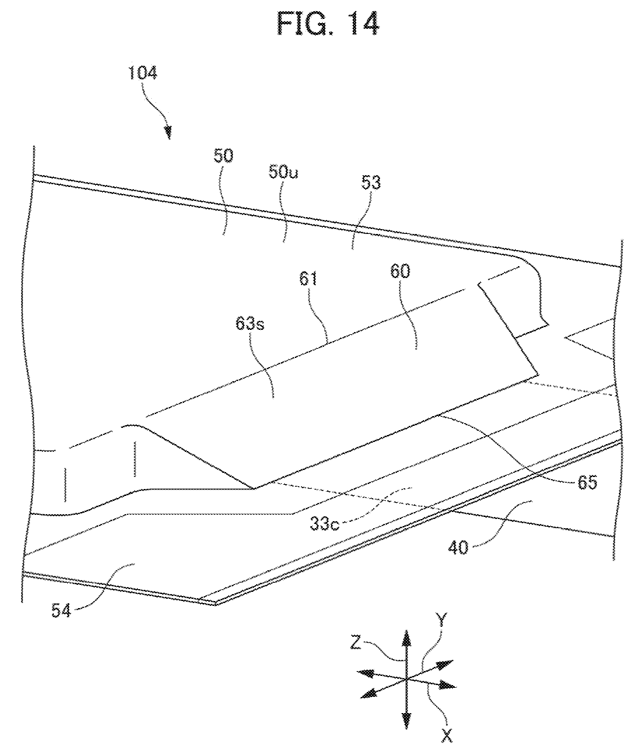

Next, with reference to FIG. 14, a fourth embodiment will be described. In the present embodiment, differences from the second embodiment will be mainly described based on the second embodiment, and descriptions of the same or similar points as those of the second embodiment will be omitted as appropriate.

The intermediate portion proximal end 61 is provided at an end in the Z direction of the end surface of the housing portion 53 in the X direction. The inclined portion 63s extends from the intermediate portion proximal end 61 to the intermediate portion distal end 65. The present embodiment is effective when it is desired that the intermediate portion 60 have a simpler shape.

### Other Embodiments

The embodiments described above can be modified as follows, for example. In each embodiment, for example, the end of the intermediate portion 60 in the Y direction shown in FIG. 3 may extend straight in the X direction. Alternatively, only the end portion on the inner side in the X direction at the end in the Y direction may be inclined to extend outward in the Y direction as it extends inward in the X direction.

### EXPLANATION OF REFERENCE NUMERALS

30 electrode laminate

31 positive electrode layer

31c positive electrode current collector (current collector)

32 solid electrolyte layer

33 negative electrode layer

33c negative electrode current collector (current collector)

40 tab lead

50 outer casing film

53 housing portion

536 protrusion

54 sealing portion

60 intermediate portion

61 intermediate portion proximal end

62 parallel portion

63s inclined portion

65 intermediate portion distal end

68 end of intermediate portion in Y direction

682 proximal end side section

683 predetermined portion

684 distal end side section

101 all-solid-state battery

102 all-solid-state battery

103 all-solid-state battery

104 all-solid-state battery

Rg1 outer region of three regions

Rg2 central region of three regions

Rg3 outer region of three regions

Sp space

vL virtual straight line

xA size in X direction from electrode laminate to intermediate portion proximal end

xB2 size in X direction from intermediate portion proximal end to intermediate portion distal end

yB1 length of intermediate portion proximal end in Y direction

yB2 length of intermediate portion distal end in Y direction

θa angle of virtual straight line with respect to X direction

θb1 angle of extending direction of proximal end side section with respect to X direction

θb2 angle of extending direction of distal end side section with respect to X direction

What is claimed is:

1. An all-solid-state battery comprising:
an electrode laminate in which a plurality of layers extending in a predetermined X direction and a predetermined Y direction orthogonal to the X direction are laminated in a Z direction orthogonal to the X direction and the Y direction; and an outer casing film,
the outer casing film comprising a housing portion that houses the electrode laminate therein, and a sealing portion that is provided around the housing portion when viewed in the Z direction,
an inside of the outer casing film being at a reduced pressure compared to an outside thereof,
the electrode laminate comprising, as the layers, at least a positive electrode layer, a solid electrolyte layer, and a negative electrode layer,
each of the positive electrode layer and the negative electrode layer comprising a current collector,
the current collector being electrically connected to a tab lead that passes through the sealing portion in the X direction and that extends to the outside of the outer casing film,
the outer casing film comprising an intermediate portion between the housing portion and a portion of the sealing portion welded to the tab lead,
the intermediate portion having an intermediate portion proximal end as an end on a housing portion side and an intermediate portion distal end as an end on a sealing portion side,
a space being formed between the electrode laminate and the intermediate portion proximal end, and
a size in the X direction from the electrode laminate to the intermediate portion proximal end being smaller than a size in the X direction from the intermediate portion proximal end to the intermediate portion distal end.

2. The all-solid-state battery according to claim 1, wherein a protrusion protruding outward in the Z direction with respect to a portion of the housing portion that abuts against an end surface of the electrode laminate in the Z direction is formed in a portion of the housing portion between the end surface of the electrode laminate in the Z direction and the intermediate portion proximal end.

3. The all-solid-state battery according to claim 1, wherein the intermediate portion proximal end is provided in a central region of three regions defined by division, in the Z direction, of a region from an end of the outer casing film in the Z direction to the tab lead into three equal regions.

4. The all-solid-state battery according to claim 1, wherein when viewed in a natural state before the inside of the outer casing film is brought to the reduced pressure, the intermediate portion has a parallel portion extending in the X direction and the Y direction substantially parallel to the sealing portion between the intermediate portion proximal end and the intermediate portion distal end.

5. The all-solid-state battery according to claim 1, wherein, when viewed in the Y direction, the intermediate portion has an inclined portion extending in a direction oblique to the X direction between the intermediate portion proximal end and the intermediate portion distal end.

6. The all-solid-state battery according to claim 1,
wherein a length of the intermediate portion distal end in the Y direction is smaller than a length of the intermediate portion proximal end in the Y direction, and
wherein, when viewed in the Z direction, at an end of the intermediate portion in the Y direction, an angle of a virtual straight line connecting the intermediate portion proximal end and the intermediate portion distal end with respect to the X direction is greater than 45°.

7. The all-solid-state battery according to claim 1,
wherein at an end of the intermediate portion in the Y direction, a predetermined proximal end side section is provided on a portion located toward the intermediate portion proximal end relative to a predetermined portion, and a predetermined distal end side section is provided on a portion located toward the intermediate portion distal end relative to the predetermined portion, and
wherein, when viewed in the Z direction, an angle of an extending direction of the distal end side section with respect to the X direction is greater than an angle of an extending direction of the proximal end side section with respect to the X direction.

8. A method for producing an all-solid-state battery, the all-solid-state battery comprising:
an electrode laminate in which a plurality of layers extending in a predetermined X direction and a predetermined Y direction orthogonal to the X direction are laminated in a Z direction orthogonal to the X direction and the Y direction; and an outer casing film,
the outer casing film comprising a housing portion that houses the electrode laminate therein, and a sealing portion that is provided around the housing portion when viewed in the Z direction,
an inside of the outer casing film being at a reduced pressure compared to an outside thereof,
the electrode laminate comprising, as the layers, at least a positive electrode layer, a solid electrolyte layer, and a negative electrode layer,
each of the positive electrode layer and the negative electrode layer comprising a current collector,
the current collector being electrically connected to a tab lead that passes through the sealing portion in the X direction and that extends to the outside of the outer casing film,
in a pre-pressure reduction stage before the inside of the outer casing film is brought to the reduced pressure,
the outer casing film comprising an intermediate portion between the housing portion and a portion of the sealing portion welded to the tab lead,
the intermediate portion having an intermediate portion proximal end as an end on a housing portion side and an intermediate portion distal end as an end on a sealing portion side,
a space being formed between the electrode laminate and the intermediate portion proximal end, and
a size in the X direction from the electrode laminate to the intermediate portion proximal end being smaller than a size in the X direction from the intermediate portion proximal end to the intermediate portion distal end,
the method comprising reducing pressure of the inside of the outer casing film from a state of the pre-pressure reduction stage.
